(19) United States
(12) Patent Application Publication
(10) Pub. No.: US 2021/0044491 A1
(43) Pub. Date: Feb. 11, 2021

(54) REMOTE CONTROL GUI FOR NETWORKED TOUCHSCREENS

(71) Applicant: CRESTRON ELECTRONICS, INC., ROCKLEIGH, NJ (US)

(72) Inventors: Dhaval K. Shah, Parsippany, NJ (US); Hemant K. Dhanrajani, Bardonia, NY (US); Srivathsan Kumar, Bangalore (IN); Mayank K. Garg, Bangalore (IN)

(73) Assignee: CRESTRON ELECTRONICS, INC., ROCKLEIGH, NJ (US)

(21) Appl. No.: 16/531,254

(22) Filed: Aug. 5, 2019

(51) Int. Cl. H04L 12/24; G06F 3/0482; G06F 3/0488; H04L 29/08

(52) U.S. Cl. CPC H04L 41/22; G06F 3/0482; G06F 3/0488; H04L 67/06; H04L 67/28; H04L 67/02; H04L 67/10

(57) ABSTRACT

A user interface that captures mouse click events which are then replicated as operational touch commands at the deployed touchscreen. Operational touch commands are functionally equivalent to those generated as a result of physically touching the display screen of a touchscreen. Providing content which mirrors a touchscreen's display allows a remote user to verify the visual appearance of the deployed touchscreen's GUI, also allows a remote user to quickly appreciate the visual effect and layout of any modifications which alter the remote touchscreen's GUI, and allows a remote user to verify the GUI's functionality of the remotely deployed touchscreen.

### BACKGROUND OF THE INVENTION

### Technical Field

The present disclosure relates to a graphical user interface (GUI) for the remote touch control of control system touchscreens by a remotely networked computer using a network service.

### Description of Related Art

Building controls systems enable the control of lighting, heating, ventilation and air conditioning (HVAC), window treatments (e.g., shades or curtains), lawn irrigators, decorative water fountains, audio-visual (AV) equipment, and other similar appliances throughout a residential or commercial building.

The popularity of using touchscreens having a graphical user interface for interacting with building control systems has also increased in recent years. The various devices connected to building control systems can be controlled using one or more graphical user interfaces that provide for immediate remote control or the designation of a programmed control schedule.

Nonetheless, it is common for those tasked with designing and commissioning touchscreens for building control systems to spend a significant amount of time and resources traveling onsite to physically validate and test the programmed functionally of the GUI of those touchscreens. Likewise, the amount of effort required increases as the number of touchscreens that require configuration increases.

Accordingly, there is a need for methods, systems, and interfaces that provide system designers and administrators a better way to develop, commission and manage touchscreens deployed remotely across one or more building control systems.

### BRIEF SUMMARY OF THE INVENTION

To briefly summarize, the present disclosure relates to systems and methods for implementing a graphical user interface that provides a user the ability to interact with the content displayed on a remote touchscreen that is deployed within the context of a control system. A user is presented with image content mirroring a remote touchscreen's display within a graphical user interface which captures mouse click events which are then replicated as operational touch commands at the deployed touchscreen. Operational touch commands are functionally equivalent to those generated as a result of physically touching the display screen of a touchscreen.

Providing content which mirrors a touchscreen's display allows a remote user to verify the visual appearance of the deployed touchscreen's Graphical User Interface. Furthermore, it also allows a remote user to quickly appreciate the visual effect and layout of any modifications which alter the remote touchscreen's Graphical User Interface. Still further, it allows a remote user to verify the Graphical User Interface's functionality of the remotely deployed touchscreen. Although specific advantages have been enumerated above, various embodiments may include some, none, or all of the enumerated advantages.

According to one aspect, a Graphical User Interface is generated within a web browser application on a computer connected to the Internet. The Graphical User Interface allows a user to see what is displayed on the remote touchscreen. The Graphical User Interface allows a user to interact with the touchscreen as if they were actually touching the physical surface of the screen by translating local mouse cursor events (e.g. clicking on an image within a web browser) to operational touch commands at a remotely controlled touchscreen. Operational touch commands are functionally equivalent to those commands generated as a result of physically touching the display screen of a touchscreen.

According to one embodiment, a user is able to interact with Graphical User Interface elements currently being displayed at the remote touchscreen by instead interacting with a screenshot image (i.e., an image that mirrors the content of the remote touchscreen's display) displayed within a web browser executing on a client PC computer over an Internet connection to a web based portal hosted by a cloud infrastructure server. A mouse-click event listener is used to detect mouse clicks made directly upon the screenshot image displayed within the web browser. Any detected mouse clicks are subsequently transmitted over the Internet connection to a listening module (executing on remote touchscreen).

In one implementation, the cloud infrastructure server is used as an intermediate proxy server for all communication between the client PC computer and remote touchscreen.

In one implementation, a user is required to first successfully authenticate prior being access is granted on the web based portal. In some implementations, the network connection from client PC computer, to the cloud infrastructure server, is a Secure HTTPS connection over the Internet (as defined, for example, by RFC 2660).

According to another aspect, the cloud infrastructure server actively maintains a listing of automation devices located at a specific site which are available for control or programming and provides a cloud Application Programming Interface (CAPI) for the management of devices (including touchscreens). In one implementation, a Representational State Transfer (REST) and Simple Object Access Protocol (SOAP) framework is used as an infrastructure to remotely administrator deployed devices (including touchscreens.) The Representational State Transfer (REST) architecture is used to define a set of rules to be used for creating web services and provide interoperability among the deployed building controls system devices over the Internet. Representational State Transfer Web Services allow for the access and manipulate of textual representations of Web resources by using a predefined set of stateless operations. The use of the Simple Object Access Protocol provides for extensibility can be is used to define the structure (e.g., XML) of messages exchanged.

In one embodiment, the computing resources of the controlled remote touchscreen, web browser, cloud infrastructure server, including network bandwidth thereby, are conserved by using screenshot images that is transmitted only at a specified periodic time-interval. In an embodiment, that periodic time-interval is specified by the user using a GUI widget presented within the web browser. In one embodiment, the default fixed time interval is two seconds.

In one embodiment, additional Graphical User Interface controls are displayed within the web browser in order to provide the ability to perform one of the following: access full device settings; receive device status feedback; perform firmware upgrades; read/write a devices scheduled actions; preform end-user software license management; administer user account levels of access/permission; manage and review device audit logs (including those of dedicated control-system processors); upload/download control programs to deployed control systems or any of their devices.

Accordingly, by passing the respective interactions directly to the remotely deployed touchscreen as operational touch commands as if they occurred directly on the surface of the touchscreen and, a user can remotely interact, view, and monitor deployed touchscreen devices without having to be physically present at the device. However, modifications, additions, or omissions may be made to the systems, apparatuses, and methods described herein without departing from the scope of the disclosure. For example, substituting the web browser for program code that is natively executed which “incorporates” web technologies like JavaScript, Hyper Text Markup Language (HTML), and Cascading Style Sheets (CSS) built into a desktop application, for example, using an open source framework like Electron™. Moreover, the operations of the systems and apparatuses disclosed herein may be performed by more, fewer, or other components and the methods described may include more, fewer, or other steps. Additionally, steps may be performed in any suitable order.

Exemplary embodiments illustrated in the figures are intended to be considered as illustrative rather than limiting. The various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING

FIG. 1 shows a PC application network diagram in accordance with one embodiment of the present disclosure.

FIG. 2 shows a PC Application Technology Stack that is suitable for use with an embodiment of the present disclosure.

FIG. 3 shows a PC application flowchart suitable for use with an embodiment of the present disclosure.

FIG. 4 shows the continuation of the PC application flow chart of FIG. 3 in accordance with the present disclosure.

FIG. 5 shows a Cloud based Web Application Network suitable for use with an embodiment of the present disclosure.

FIG. 6 shows a Cloud based web architecture and Technology stack suitable for use with an embodiment of the present disclosure.

FIG. 7 shows a Cloud based web application flowchart suitable for use with an embodiment of the present disclosure.

FIG. 8 show a GUI suitable for use with an embodiment of the present disclosure.

FIG. 9 shows a GUI suitable for use with an embodiment of the present disclosure.

FIG. 10 shows a GUI suitable for use with an embodiment of the present disclosure.

FIG. 11 shows a GUI suitable for use with an embodiment of the present disclosure.

FIG. 12 shows a GUI suitable for use with an embodiment of the present disclosure.

FIG. 13 shows a GUI suitable for use with an embodiment of the present disclosure.

### LIST OF REFERENCE NUMBERS FOR THE MAJOR ELEMENTS IN THE DRAWING

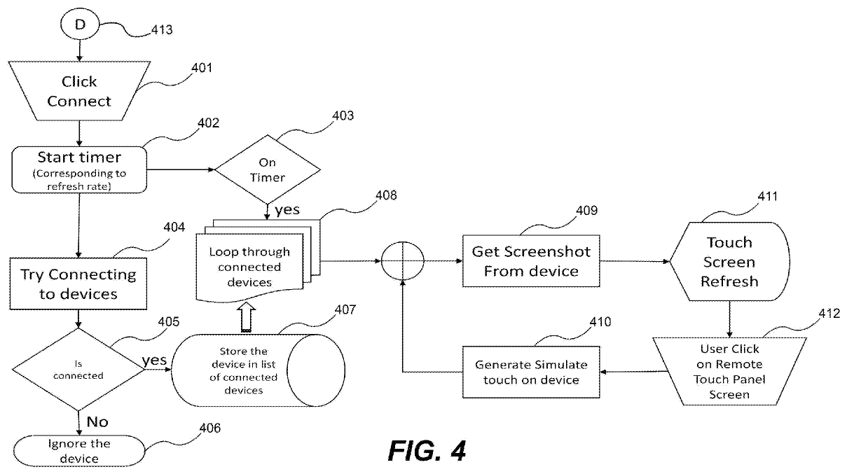

The following is a list of the major elements in the drawings in numerical order.
101 Personal Computing (PC) device
102 Device Remote Control Application
103 Secure Shell (SSH) cryptographic network protocol for operating network services securely over an unsecured network/Secure File Transfer Protocol (SFTP) is a cryptographic which works with SSH to transmit files over a secure connection
104 Network Firewall
105 A first SFTP connection
106 A second SFTP connection
107 A third SFTP connection
108 Local Area Network (LAN)
109 A first device set
110 A second device set
111 A device
201 An application layer
202 A platform/framework layer
301 Step of launching the application
302 Step of selecting the refresh rate
303 Step of determining if the devices are in a IP range
304 Step of inputting the start and end Internet Protocol (IP) address range
305 Step of entering the credentials needed to authenticate with the devices in the IP range
306 Step of selecting the devices' type from the dropdown box of the Graphical user interface (GUI)
307 Step of inputting a specific device IP address
308 Step of entering the credentials needed to authenticate with the device specified
309 Step of selecting the device type from the dropdown box of the Graphical user interface (GUI)
310 Step of determining if there are additional devices to specify for control
311 Step of logically jumping to from “D” to the “D” shown in FIG. 4
401 Step of clicking on the connect button to start controlling the devices selected
402 Step of starting a timer for the selected refresh interval
403 Step of deciding if is timer up for event trigger
404 Step of trying to connect the devices selected with the specified authentication details
405 Step of deciding if the initial device connections were successful
406 Step of determining if the initial connection failed, to ignore the device
407 Step of determining if the initial connection succeeds, store the device in a list of connected devices
408 Step of on the timer event, looping through the device list and performing the step of 409
409 Step of triggering a screenshot capture on the device and fetch the screenshot file from device to local pc
410 Step of simulating a touch action on the device based on calibrated user click using the touchscreens firmware functionality
411 refresh the touchscreen image in the application
412 Step of waiting for user click on the simulated touchscreen
501 An Internet of Things (IoT) Graphical User interface (GUI)
502 A second remote device control
503 Hypertext Transfer Protocol Secure (HTTPS) used for secure communication over a computer network (Commonly known as RFC 2660)
504 An Internet of Things (Iot) cloud service network
505 A fourth device set
506 A fifth device set
507 A second device
508 A first Internet of Things (IoT) device tunnel
509 A second Internet of Things (IoT) device tunnel
510 A third Internet of Things (IoT) device tunnel
601 Touch panel based device sets
602 Corporate LAN to Internet bridge (through firewall)
603 Secure device tunnel, for device to cloud communication
604 cloud infrastructure
605 Secure HTTP connection from cloud to PC (through internet)
606 Web based portal
701 Step of logging into the portal with credentials
702 Step of selecting the device to be controlled
703 Step of deciding if the user is authorized to control device remotely
704 Step of determining if user is not authorized, displaying a blank page with error
705 Step of determining if user is authorized, store the device in the list of devices to be controlled
706 Step of running a timer task for periodic refresh of the touchscreen
707 Step of determining if on timer, looping through the list of devices
708 Step of triggering a screenshot on the device and fetching the screenshot from device to cloud server
709 Step of refreshing the web portal with the new image
710 Step of waiting for user click on the screenshot
711 Step of simulating the click action on the device using the firmware feature
801 Dial knob widget to adjust the refresh rate
802 Current value of the refresh rate
803 IP range label
804 Button to connect and start controlling the devices
806 Text box to enter starting IP address
807 Text box to enter ending IP address
812 Text box to enter device range's user name
813 Text box to enter device range's password
814 Drop down to select device type
817 Widget to add another device or device range
901 Dial knob widget to adjust the refresh rate
902 Current value of the refresh rate
903 IP range label
904 Button to start controlling the devices
906 Text box to enter starting IP address
907 Text box to enter ending IP address
908 Text box to enter second range starting IP address
909 Text box to enter second range ending IP address
912 Text box to enter device range user name
913 Text box to enter device range password
914 Drop down to select device type
915 Drop down to select second range device type
917 Widget to remove existing device or device range
918 Widget to add another device or device range
1001 Dial knob widget to adjust the refresh rate
1002 Current values of the refresh rate
1003 IP range label
1004 Button to start controlling the devices
1006 Text box to enter starting IP address
1007 Text box to enter ending IP address
1008 Text box to enter second range starting IP address
1009 Text box to enter second range ending IP address
1010 Text box to enter third range starting IP address
1011 Text box to enter third range ending IP address
1012 Text box to enter device range user name
1013 Text box to enter device range password
1014 Drop down to select device type
1015 Drop down to select second range device type
1015 Drop down to select third range device type
1017 Widget to remove existing device or device range
1018 Widget to remove existing device or device range
1019 Widget to add another device or device range
1101 IP address of touchscreen being controlled
1102 Widget to zoom the specific touchscreen instance
1201 Widget to zoom the specific touchscreen instance
1202 The specific instance zoomed
1301 the URL of a cloud-based web portal instance which permits remote touchscreen control.
1302 Web browser
1303 Remote touchscreen content

### DETAILED DESCRIPTION OF THE INVENTION

The present disclosure is generally implemented as part of a networked computer system including a touchscreen device that is located remotely from a controlling computer, hence, such an illustrative networked computer system and its operation will be described initially.

The present disclosure provides numerous specific details set forth to provide a thorough understanding of the various described implementations. However, it will be apparent to one of ordinary skill in the art that the various described implementations may be practiced without these specific details.

The terminology used in the present disclosure is to describe particular implementations only and is not intended to be limiting. As used in the description of the various described implementations and the appended claims, the singular forms “a,” “an,” and “the” are intended to include the plural forms as well, unless the context indicates otherwise. It will also be understood that the term “and/or” as used herein refers to and encompasses any possible combinations of one or more of the associated listed items.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

It is to be appreciated that the control system deployments described herein may refer to residential or commercial building environments, but the scope of the present teachings is not so limited. The present teachings are also applicable, without limitation, to duplexes, townhomes, multi-unit apartment buildings, hotels, retail stores, office buildings, industrial buildings, and more generally any residential or commercial space.

It is also to be appreciated that while the terms user, administrator, customer, end-user, installer, and the like may be used to refer to the person or persons acting in the context of some particular situations described herein, these references do not limit the scope of the present teachings with respect to the person or persons who are performing such actions. Thus, for example, the terms user, customer, installer, or subscriber, may refer to the same person, if that person purchases, installs, commissions and uses the control system or any of its devices. Therefore, the use of such identity in the present disclosure should not be construed in the descriptions that follow as necessarily limiting to specified identities.

The preferred embodiment of the present disclosure is described herein in the context of the remote touch control of plural control system touchscreens by a remote networked computer using a cloud server as a proxy but is not limited thereto, except as may be set forth expressly in the appended claims.

In some embodiments graphical user interfaces are provided to the end user via interpreted hyper-text markup language code interpreted within a web browser application. In other embodiments, code is natively executed which “incorporates” web technologies like JavaScript, HTML, and CSS which are built into a desktop application, for example, using an open source framework like Electron™ (https://electronjs.org/). Electron applications are composed a “browser” process and “renderer” process, the browser process encapsulates the core application logic and window GUI management. Renderer processes launch GUI windows that rendering HTML and CSS on a user's screen. Throughout this description therefore, we refer to GUI's targeted for a web browser application and a native application which includes web-based rendering technologies.

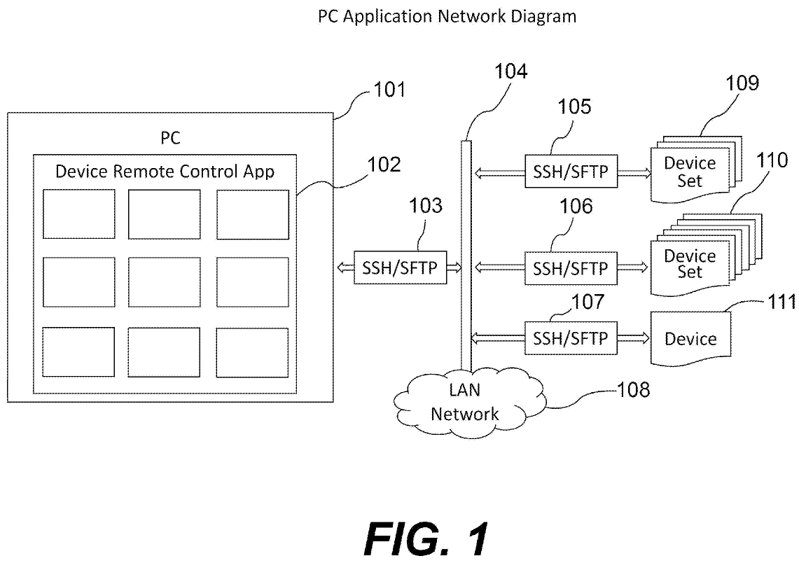

FIG. 1 shows an illustrative embodiment in the context of a Personal Computing (PC) device 101 executing Device Remote Control Application 102 thereon. In an embodiment, Secure Shell (SSH) and Secure File Transfer Protocol (SFTP) connection 103 is established through network firewall 104 over a LAN Network 108.

In one embodiment, a first set of SFTP connection 105 is established to a first device set 109, a second SFTP connection 106 is made to a second device set 110, and a third SFTP connection 107 is made to a single device 111. In this embodiment, device sets 109, 110, and 111 are devices deployed at a specific installation site and reside on common Local Area Network (LAN) 108.

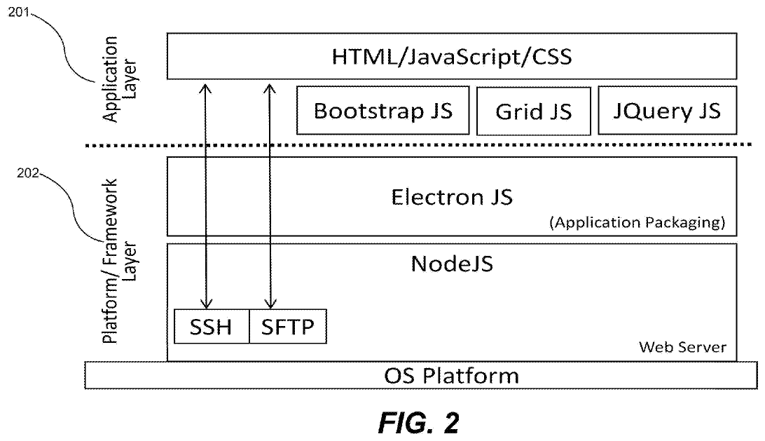

Referring now to FIG. 2, which shows an application layer 201 which preferably includes Bootstrap.js, which is a library of pre-configured components that enhance front-end development. The Bootstrap.js library includes JS and Cascading Style Sheets (CSS) which make it easier for developers to lay out a grid of components on a screen. While this grid allows some measure of “responsive” design, it does not allow dynamic re-sizing or intelligent selection of components at runtime. Platform/framework layer 202, preferably includes elements implemented using Node.js®. Nodejs® modules to handle various core functionalities.

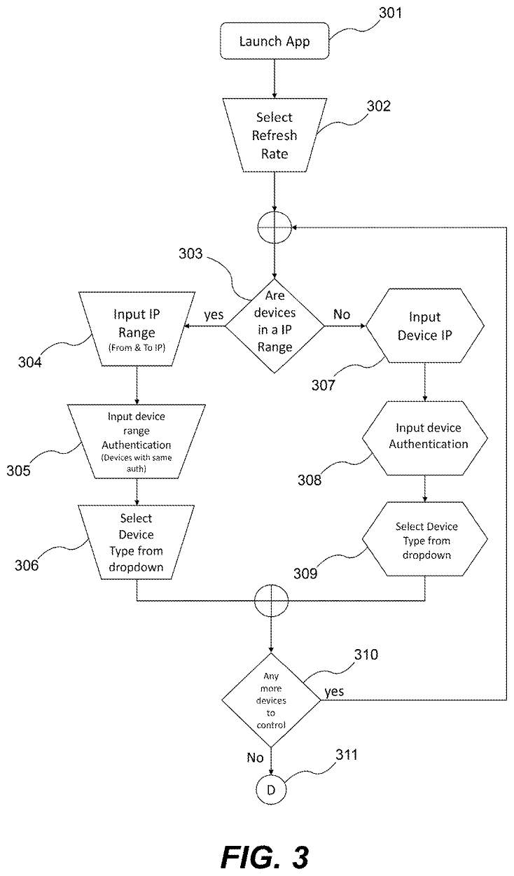

FIG. 3 shows the Step of launching application 301. After launching application 301, the user selects the refresh rate 302. The user specifies if the devices are in a IP range and in response, the application determines if the devices are in a IP range 303. If they are in a range the user inputs the start and end Internet Protocol (IP) address range 304. Then the user enters the credentials needed to authenticate with the devices in the IP range 305. In one embodiment, the user further selects the devices' type from the dropdown box of the Graphical user interface (GUI) 306.

In another embodiment, after the user selects the refresh rate 302, the user specifies a specific device IP address 307. Then the user enters the credentials needed to authenticate with the device specified 308. In one embodiment, the user further selects the device type from the dropdown box of the Graphical user interface (GUI) 309.

In some embodiments, after the step of determining if there are additional devices to specify for control 310 we next refer to “D” shown in FIG. 4 311.

Referring now to FIG. 4, the user clicks on the connect button to start controlling the devices selected 401. An attempt to connect the devices selected with the specified authentication details 404 is performed and it is decided if the initial device connections were successful 405. If the initial connection(s) fail, the device is ignored 406. If the initial connection succeeds the device is stored in a list of connected devices 407.

When timer for a selected refresh interval 402 expires 403, a loop through the device list is performed 408 which triggers a screenshot capture on the devices and fetches the screenshot files from device(s) to local PC 409. Simulating a touch action on the device based on calibrated user click is accomplished using the touchscreen's firmware functionality 410. In one embodiment, this also causes a refresh of the touchscreen image in the application 411, as soon as a user clicks on the GUI 412.

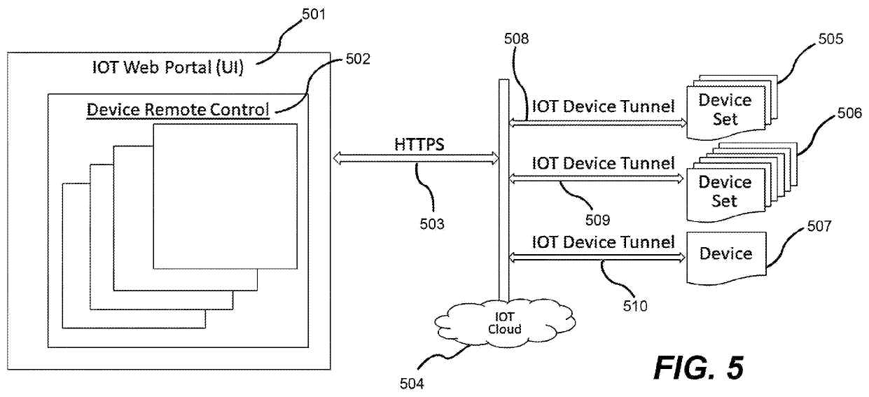

FIG. 5 illustrates an embodiment which utilizes a cloud computing infrastructure for controlling and managing one or more touchscreens, such as those which may exist within a fourth device set 505, a fifth device set 506, or one which stands alone as a second device 507, according to an embodiment. It should be noted that the exemplary embodiment of system illustrated in FIG. 5 may be varied in one or more aspects without departing from the spirit and scope of the teachings disclosed herein. Accordingly, the present embodiments deliver touchscreen control and management via cloud computing on server 504 without the responsibilities of managing proprietary equipment, servers, or software. According to an embodiment, a cloud based Internet of Things (IoT) Graphical User interface (GUI) 501 provides for embedded remote device control 502 using Hypertext Transfer Protocol Secure (HTTPS) (Commonly known as RFC 2660) in order to secure communication over computer network 503. In embodiment, a first Internet of Things device tunnel 508, second Internet of Things device tunnel 509, and third Internet of Things device tunnel 510, are used to connect devices 505,506, and 507 to the cloud in a secure and standard way. Cloud server 504 may be used to aggregate multiple devices 505, 506, and 507 into a centralized management and control platform. The Cloud server 110 may provide similar functions as a localized building control system processor and also comprise additional services.

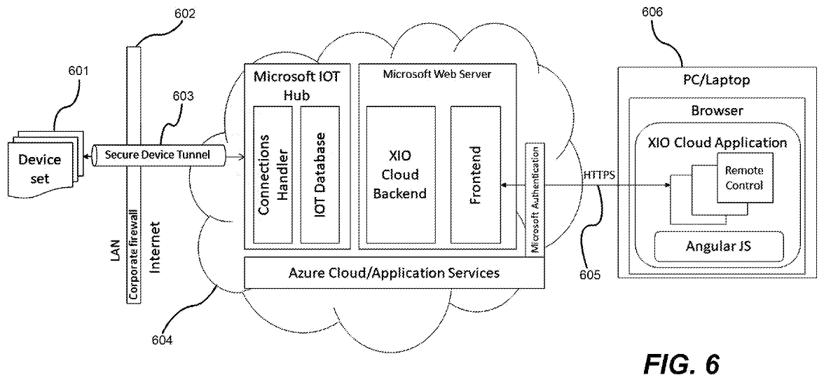

FIG. 6 illustrates details of an embodiment utilizing a cloud application service. In one embodiment, Cloud Server 604 is incorporated into a conventional standalone server, although in other embodiments, the function of cloud server 604 may be distributed across multiple computing systems and architectures. Multiple, redundant cloud servers may be provided for additional backup and security. For example, cloud server 604 may include a separate web server and Connection Hub.

It is preferable cloud server 604 is always actively available online, and accessible to any networked computing device such as PC/Laptop 606. Application Services may be run on the cloud server 604 and may include a web server software application which serves content to a web browser running on PC/Laptop 606. The number and types of applications, software engines, and data storage areas may be varied and, as such, the specific arrangement discussed herein is presented primarily for descriptive purposes.

PC/Laptop 606 establishes a connection, that in some embodiments includes authentication with credentials, by entering the cloud server's 604 host name or IP address into a Uniform Resource Locator (URL) of a web browser running on PC/Laptop 606.

In one embodiment, the connection between Cloud server 604 and PC/Laptop 606 conforms to security protocol HTTPS 605 and Cloud server 604 establishes a Secure Device tunnel 603 a device set 601.

Cloud Server 604 may comprise one or more connection handlers to provide connectivity with, among other things, device set 601. Databases may be used to store IP address one or more device sets 601. According to an embodiment, the Cloud Server 604 includes the capability to establish secure IOT device tunnel 603 to connect directly over the internet through a firewall 602 to device set 601. Alternatively, the internet connection may include various physical network layers including, a cellular data network, such as the Enhanced Data rates for GSM Evolution (EDGE) network or other 2G, 3G, and/or 4G, or any other type of physical network layer.

Cloud Server 604 may include a central processing unit (CPU) configured for providing processing capability to execute an operating system, run various applications, and/or provide processing for one or more of the techniques described herein.

Cloud Server 604 may further include any one of numerous forms of storage, including main memory and nonvolatile storage. A main memory may be communicably coupled to the CPU and may store data and executable code. The main memory may represent volatile memory such as random access memory (RAM), but may also include nonvolatile memory, such as read-only memory (ROM) or Flash memory. In buffering or caching data related to operations of the CPU, the main memory may store data associated with various engines and modules running on the Cloud Server 604. The nonvolatile storage may represent any suitable nonvolatile storage medium, such as a hard disk drive or nonvolatile memory, such as Flash memory. Being well-suited to long-term storage, the nonvolatile storage may store data files such as media (e.g., music and video files), software (e.g., for implementing functions on the Cloud Server 604), among other types of data.

Nonvolatile storage may further include a building automation application operable to enable the control and monitoring of electronic devices 601 of the building automation system, as well as perform other operations discussed below. Building automation application may comprise a plurality of software engines. Software engines process information received from device set 601. Depending upon implementation, various aspects of teachings of the present embodiments may be implemented in a single building automation application, a plurality of applications, a single software engine, in a plurality of software engines, in one or more hardwired components or in a combination of hardwired and software systems. In addition to one or more software engines, nonvolatile storage also includes one or more data storage areas.

Software engines of the building automation application may comprise an event scheduling engine. The event scheduling engine may be configured for allowing a user to preprogram setting presents, scenes, building rules, and schedule of event of electronic device set 601.

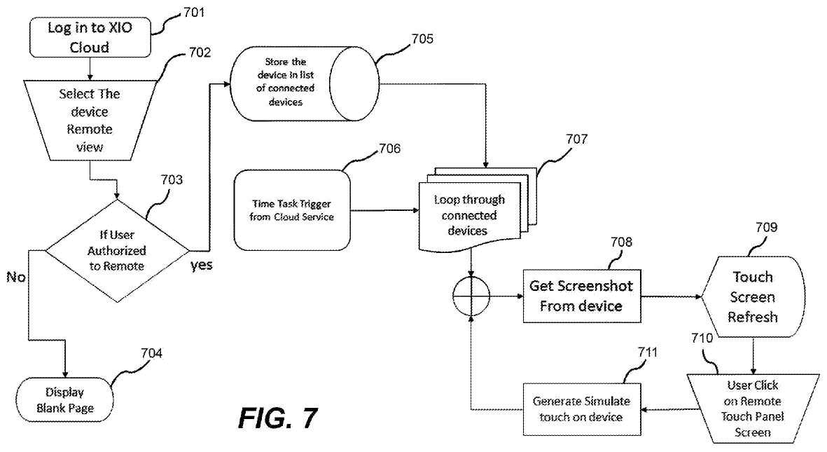

FIG. 7 shows the Step of logging into the portal with credentials 701. The device to be controlled is selected 702. It is next determined if the user is authorized to control device remotely 703. If the user is not authorized a blank page with an error is displayed 704. However, if the user is authorized, the device is stored in the list of devices to be controlled 705.

A timer task for the periodic refresh of touchscreen(s) starts running 706 and on the expiration of the timer, the list of devices is looped through 707 by triggering a screenshot on the devices and fetching the screenshot from devices to cloud server 708. The web portal is refreshed with the new screenshot images 709. After detecting a user's click on a screenshot 710, the click action is simulated on the device using the device's firmware feature 711.

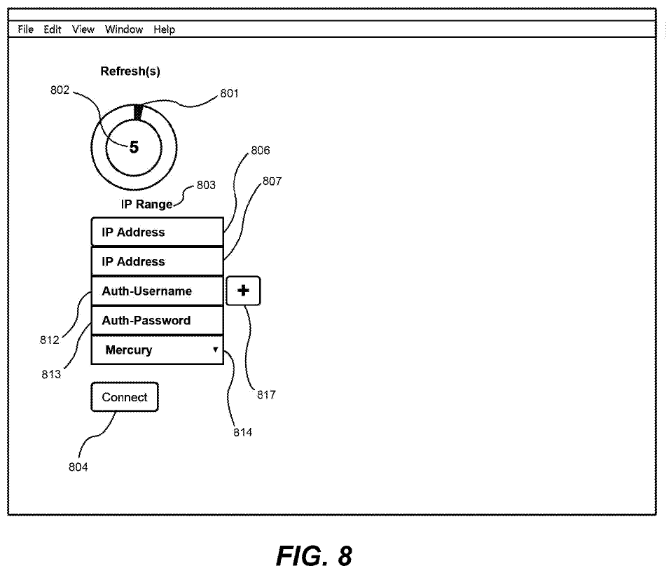

FIG. 8 shows the PC application user interface that, in one embodiment, contains a Dial knob widget to adjust the refresh rate 801. In one embodiment, the current value of the refresh rate 802 is shown. In one embodiment the IP range is designated by label 803. In an embodiment, the GUI includes: Button to connect and start controlling the devices 804; Text box to enter starting IP address 806; Text box to enter ending IP address 807; Text box to enter device range's user name 812; Text box to enter device range's password 813; Drop down to select device type 814; and Widget to add another device or device range 817.

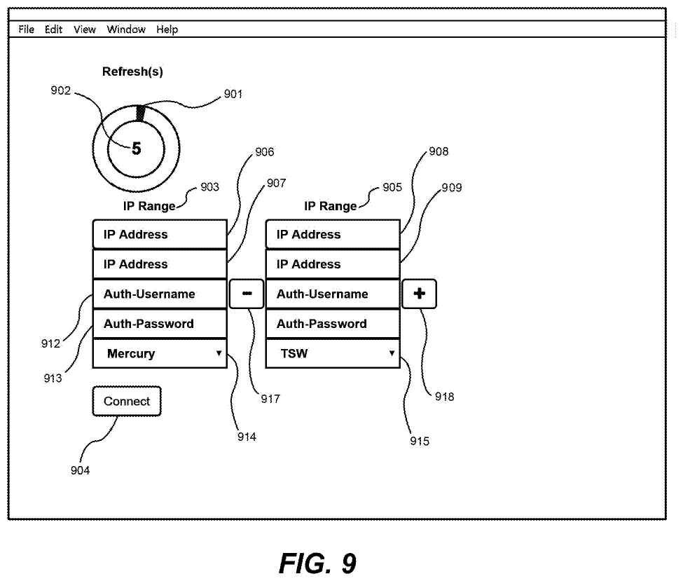

FIG. 9 shows an embodiment of a PC application supporting the control of two device ranges in the user interface which may include: Dial knob widget to adjust the refresh rate 901; Current value of the refresh rate 902; IP range label 903; Button to start controlling the devices 904; Text box to enter starting IP address 906; Text box to enter ending IP address 907; Text box to enter second range starting IP address 908; Text box to enter second range ending IP address 909; Text box to enter device range user name 912; Text box to enter device range password 913; Drop down to select device type 914; Drop down to select second range device type 915; Widget to remove existing device or device range 917; and Widget to add another device or device range 918.

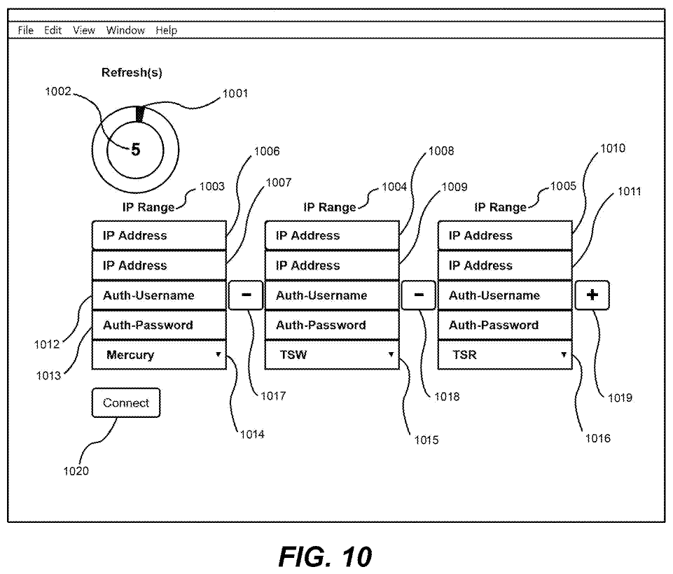

FIG. 10 shows an embodiment of a PC application supporting the control of three device ranges in a GUI having: Dial knob widget to adjust the refresh rate 1001; Current values of the refresh rate 1002; IP range label 1003; Button to start controlling the devices 1004; Text box to enter starting IP address 1006; Text box to enter ending IP address 1007; Text box to enter second range starting IP address 1008; Text box to enter second range ending IP address 1009; Text box to enter third range starting IP address 1010; Text box to enter third range ending IP address 1011; Text box to enter device range user name 1012; Text box to enter device range password 1013; Drop down to select device type 1014; Drop down to select second range device type 1015; Drop down to select third range device type 1015; Widget to remove existing device or device range 1017; Widget to remove existing device or device range 1018; and Widget to add another device or device range 1019.

It can be appreciated that the number of device ranges to be controlled can exceed the three shown in FIG. 10 by simply selecting the 1019 widget which would cause a new IP Range to appear to the right of the those already displayed. This can be repeated as many times as needed.

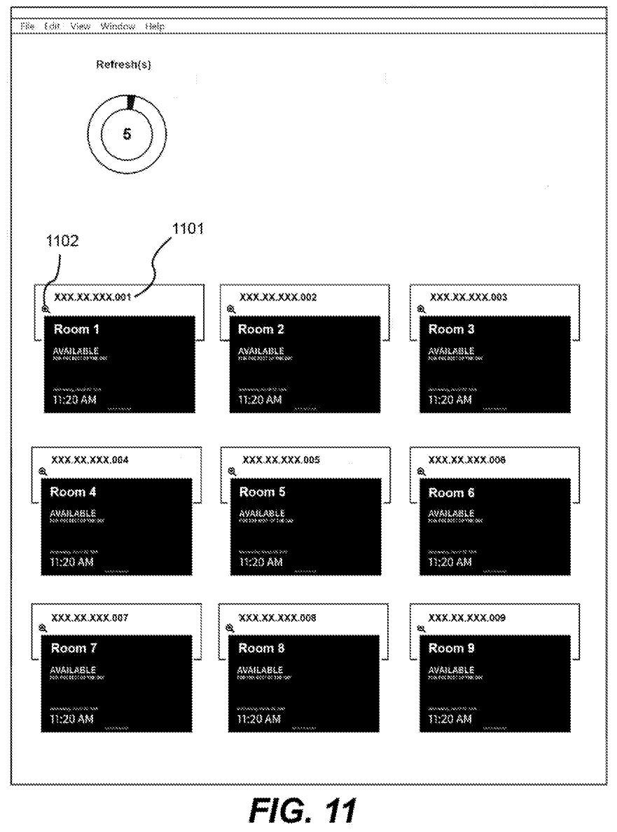

FIG. 11 shows plural devices being remotely controlled in a single screen with the IP address of touchscreen being controlled 1101, and Widget to zoom the specific touchscreen instance 1102. The specific instance of the touchscreen is zoomed upon clicking on widget 1102.

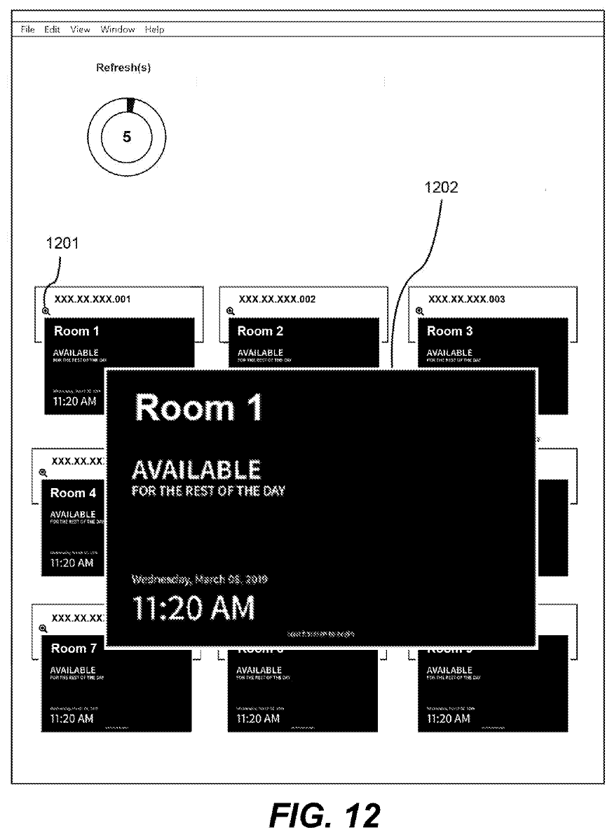

FIG. 12 shows a Widget to zoom the specific touchscreen instance 1201, and the specific instance zoomed 1202.

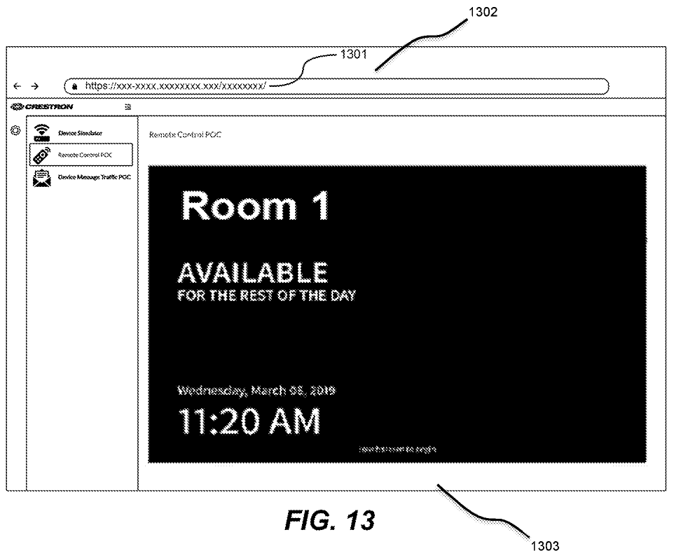

FIG. 13 shows an example of a web browser 1302 using a cloud-based web portal instance which permits remote touchscreen control 1303. The web browser points to the URL of the cloud-based web portal 1303.

What is claimed is:

1. A method for displaying and controlling a touchscreen's graphical user interface (GUI) on a web browser running on a client PC computer using a connection to a web based portal of a cloud infrastructure proxy server, the method comprising:
establishing a secure device tunnel from said cloud infrastructure server to a device set, wherein said device set comprises said touchscreen,
displaying within said web browser, a list of devices for control;
responsive to selecting said touchscreen, said touchscreen transmits the content of its display as a screenshot image to said cloud infrastructure server;
transmitting said screenshot image from said cloud infrastructure server to said client PC computer for display within said web browser;
responsive to detecting a mouse click event on said screenshot image displayed by said web browser, transmitting the coordinates of said mouse click event to said touchscreen and for generating a corresponding operational touch command at said touchscreen; and
transmitting a new screenshot image from said cloud infrastructure server to said client PC computer for display within said web browser upon detecting said mouse click event.

2. The method of claim 1, wherein:
the duration said touchscreen periodically transmits said screenshot image is specified using a GUI timer widget within said web browser.

3. The method of claim 1, wherein said connection to a web based portal of a cloud infrastructure proxy server is established using the Secure HTTPS protocol.

4. The method of claim 1, wherein said touchscreen transmits the content of its display as a screenshot image to said cloud infrastructure server using the SFTP protocol.

5. A method for displaying and controlling a touchscreen's graphical user interface (GUI) within a native application on a client PC computer using a direct connection to a touchscreen, the method comprising:
establishing said direct connection using the SSH/SFTP protocol from said client PC computer to a device set, wherein said device set comprises said touchscreen;
displaying within said native application, a list of devices for control;
responsive to selecting said touchscreen, said touchscreen transmits the content of its display as a screenshot image to said native application;
responsive to detecting a mouse click event on said screenshot image displayed by said native application, transmitting the coordinates of said mouse click event to said touchscreen and for generating a corresponding operational touch command at said touchscreen; and
transmitting a new screenshot image from said touchscreen to said client PC computer for display within said native application upon detecting said mouse click event.

6. The method of claim 5, wherein:
the duration said touchscreen periodically transmits said screenshot image is specified using a GUI timer widget within said native application.
